(19) United States
(12) Patent Application Publication
(10) Pub. No.: US 2019/0048502 A1
(43) Pub. Date: Feb. 14, 2019

(54) JET STRIP FOR A TEXTILE PROCESSING MACHINE

(71) Applicant: Groz-Beckert KG, Albstadt (DE)

(72) Inventors: Jürgen Spill, Nusplingen (DE); Achim Locher, Burladingen (DE); Thomas Schmid, Balingen (DE); Jürgen Weith, Burladingen (DE)

(21) Appl. No.: 16/077,304

(22) PCT Filed: Dec. 6, 2016
(86) PCT No.: PCT/EP2016/079955

§ 371 Date: Aug. 10, 2018

(30) Foreign Application Priority Data
Feb. 11, 2016 (EP) 16155355.7

(51) Int. Cl. D04H 18/04; B05B 1/34

(52) U.S. Cl. CPC D04H 18/04; B05B 1/34

(57) ABSTRACT

A nozzle channel (24) of a jet strip (18) extends from the first side (20) to the second side (22) of the jet strip (18) and defines a flow-through direction (30, 38). A second section (28) of the nozzle channel (24) is offset relative to a first section (26) in the direction transverse to the flow-through direction (30, 38). Preferably, the nozzle channel (24) is funnel-shaped, with a middle section (50) tapering in the direction from the first side (20) to the second side (22) and with a single asymmetrically arranged funnel neck that is formed by the second section (28

The invention relates to a jet strip for a textile processing machine and a manufacturing process for a jet strip.

To bond nonwoven fabrics, textile processing machines are known in which a fluid, e.g., water, is expelled under high pressure onto a random fiber web. The fine fluid jets entangle the fibers with one another to produce a tight nonwoven fabric. A bonding step is frequently preceded by premoistening or prebonding of the random fiber webs. This step can serve to prepare the web, in particular the horizontal and/or vertical distribution of the fibers, for the bonding. This can, for example, improve tear resistance in the direction transverse to the feed direction of the bonding machine or reduce the formation of the fluid jet lines (water jet lines) that are characteristic for fluid jet bonding. Postmoistening or post-processing, i.e., impingement of finely distributed fluid onto the bonded textile can also be desired. This can, for example, laminate the resulting characteristic fluid jet lines (water jet lines). Preparation or post-processing requires a spraying fluid jet.

To produce a spraying fluid jet, fluid is fed to a low-pressure injector, fluid being sprayed in a fluid curtain onto the random fiber web, which is moved in a feed direction under the low-pressure injector. Such a low-pressure injector is known, for example, from WO 96/35835 A1.

For the main bonding, EP 2 302 120 A1 describes an injector for a textile processing machine, the injector being set up to form concentrated, high-energy, and preferably closed jets for bonding (bonding jet). To accomplish this, the injector has a jet strip, water being pressed through the nozzle channels of the jet strip under high pressure to form needle-shaped jets.

Jet strips to produce bonding jets are disclosed in U.S. Pat. No. 7,303,465 B2, for example. Such jet strips have a top and a bottom, multiple nozzle channels extending from the top to the bottom. On the top, a nozzle channel has a cylindrical section, followed by a conical section with the same diameter that widens in the direction toward the bottom. Water is pressed through the nozzle channels under high pressure from the top, forming a thin, high-energy water jet, which strikes the random fiber web and bonds it.

Starting from this prior art, one goal of this invention can be considered to be to indicate an improved means for moistening or processing unbonded or bonded random fiber webs.

This is accomplished with a jet strip for a textile processing machine according to claim 1 and a jet strip manufacturing process according to claim 15.

The inventive jet strip has a first side and a second side and at least one nozzle channel. The preferably unbranched nozzle channel extends from the first side to the second side and defines a first flow-through direction from the first side to the second side and/or a second flow-through direction from the second side to the first side. The nozzle channel has a first section and a second section, the second section being arranged offset relative to the first section in the direction transverse to the first flow-through direction and/or the second flow-through direction. Preferably, the second section is arranged so that it is non-concentric with the first section in the direction transverse to the first and/or the second flow-through direction.

The first flow-through direction and/or the second flow-through direction can be defined especially by the first section and/or the second section of the nozzle channel. The first flow-through direction and/or the second flow-through direction can be antiparallel. The first section and/or the second section can be oriented transverse to the surface of the first side and/or transverse to the surface of the second side. The first flow-through direction and/or the second flow-through direction can, if understood as vectors, stand transverse to the surface of the first side and/or to the surface of the second side.

The first section is arranged at or in the first side of the jet strip, and the second section is arranged at or in the second side, so that when fluid impinges on the first side, this fluid first flows through the first section and then through the second section, which is fluidically connected with the first section. When fluid impinges on the second side of the jet strip, this fluid behaves in the opposite way.

If the jet strip is used, for example in an injector or water beam for premoistening, water or another liquid or gaseous fluid can impinge on its first side. This causes the fluid to enter an orifice (opening) on the first side of the jet strip into the nozzle channel, in the first flow-through direction through the first section and the second section, which can also be referred to as a nozzle, of the nozzle channel and out of a second orifice (opening) on the second side. After that, the jet strikes the random fiber web, which in this arrangement is opposite the second side.

The construction of the nozzle channel, which is preferably asymmetric due to the offset, allows the fluid in this usage position to be atomized into a spraying jet a relatively short distance behind the opening, this spraying jet being especially suitable for premoistening. The arrangement of the offset in the direction of the longitudinal extension and/or the width extension of the jet strip allows the nozzle channel to be set up to produce a jet spraying behind the second orifice with a deflection in a preferred direction in the longitudinal extension direction and/or in the transverse extension direction of the jet strip. In use, the result can be a deflection in or opposite the feed direction and/or transverse to it. The improved spray characteristics and/or deflection of the spraying jet in this usage position of the jet strip can achieve improved prebonding, improved distribution of the fibers transverse to the feed direction of the random fiber web in the bonding machine, improved maximum tear strength of the nonwoven fabric transverse to the feed direction or special suitability of the spraying jet for lamination of the fluid jet lines in the bonded textile. The size of the offset and thus possibly the size of the asymmetry can affect the size of the deflection in the preferred direction.

Alternatively or in addition, the jet strip can be set up for use in a second usage position in an injector or water beam for high-pressure bonding, and can have high-pressure fluid impinge on its second side, so that the fluid flows through nozzle channel in the second flow-through direction from the second side to the first side, first through the second section and then through the first section. Preferably, in this usage position the jet strip is set up to produce a bonding jet for the main bonding. To accomplish this, the high-pressure fluid enters the nozzle channel on the second side and in the second section forms a bonding jet that exits from the nozzle channel, preferably as unaffected as possible by the first section and the offset between the first section and the second section. To form a bonding jet, the ratio of the length of the second section to the diameter of the second section can be, for example less than or equal to 1.4. This can produce an especially concentrated, high-energy closed jet.

In the embodiment in which the jet strip is set up to be used in both usage positions, the nozzle channel forms a two-way nozzle channel . In this embodiment it can be sufficient if the textile manufacturer keeps only one sort of jet strip on hand. A jet strip that has reached the end of its service life in the usage position for producing the bonding jet can be used after that in the usage position for premoistening, for example. This makes it possible to avoid waste and reduces recycling expense.

The first section is bordered by a first wall surface and the second section is bordered by a second wall surface transverse to the flow-through direction. The first wall surface and/or the second wall surface can be, for example, a section of a surface of revolution, interrupted or uninterrupted in the peripheral direction, e.g., a lateral surface of a cylinder or of a frustum of cone, this lateral surface defining an axis of rotation. The first wall surface and/or the second wall surface can also be, for example, angular, symmetrical or asymmetrical, or irregularly shaped. Preferably, the first wall surface and/or the second wall surface are straight in longitudinal section through the nozzle channel. The first wall surface and/or the second wall surface can, for example, stand perpendicular to the surface of the first side and/or the surface of the second side.

If this application mentions a peripheral direction, what is meant is a direction around the first and/or the second flow-through direction. If this application mentions a cylinder, cone or frustum of cone, or a lateral surface of a cylinder or frustum of cone, what is meant is preferably a right cylinder or a right cone or frustum of cone, in the sense that the axis of the cylinder or cone is perpendicular to the (imaginary) base of the cylinder or the cone or the frustum of cone. An (imaginary) base of the cylinder or the cone or the frustum of cone is preferably parallel to the first side and/or the second side.

Preferably every nozzle channel has its own first section, so that every first section of the nozzle channel is fluidically separated, in the direction transverse to the flow-through direction, from the first section of every other nozzle channel by the first wall surface. In addition, every nozzle channel preferably has its own second section, so that every second section of the nozzle channel is fluidically separated, in the direction transverse to the flow-through direction, from the second section of every other nozzle channel by the second wall surface of the second section.

Preferably the first section and the second section each define a central axis, the central axis of the second section being offset, in particular offset in parallel, to the central axis of the first section. This makes it possible to define the offset of the second section relative to the first section in the direction transverse to the first flow-through direction and/or the second flow-through direction. The central axis of the first and/or second section can define the first and/or the second flow-through direction. In the case in which the first or second section is cylindrical or conical, or bordered by a surface revolution, the central axis can be, for example, the axis of a cylinder or a cone, or generally the axis of rotation. The central axis of the first section can be an axis of symmetry of the first section. The central axis of the second section can be an axis of symmetry of the second section. The central axis of the first section and/or the central axis of the second section can be oriented transverse to the surface of the first side and/or transverse to the surface of the second side. Preferably the central axis of the second section is oriented transverse to the surface of the second side. In this way, it is preferably the offset that principally determines any preferred direction of the spray jet along the surface of the second side onto the second side in the usage position to produce a jet spraying early, i.e., at a relatively short distance behind the second side.

It is preferred that the diameter of the first section be greater than the diameter of the second section. It is especially preferred that the diameter of the first orifice be greater than the diameter of the second orifice. Irrespective of the orientation of the central axes of the first section and the second section, the second section is, transverse to the first and/or second flow-through direction, preferably arranged within the projection of the first section and/or first orifice onto the second side of the jet strip in the direction of the thickness dimension of the jet strip (transverse to the first side) or of the first flow-through direction. If the first section and the second section define the central axes, the extension of the central axis of the first section is preferably arranged within the second section. The offset distance measured between the central axis of the first section and the central axis of the second section is preferably less than or equal to half the difference of the diameter of the first section and the diameter of the second section.

The inventive jet strip with at least one of the above-described features is especially simple to produce. This additionally allows the nozzle channels to be arranged especially closely.

Preferably the first section is longer in the flow-through direction than the second section is. Material between the first sections of the nozzle channels can serve to stiffen the jet strip. A long first section can already impart a flow-through direction to the fluid flowing through from the first side to the second side. Thus, a long first section can have a flow-directing effect on the fluid, which thus flows to the second section in the defined flow-through direction. Preferably the first section is longer in the flow-through direction than the second section is by at least a factor of 3.

Between the first section and the second section, the nozzle channel can have a middle section, which has a middle section wall surface that borders the latter in the direction transverse to the first and/or second flow-through direction. The middle section wall surface can be, for example, a section of a surface of revolution, this section being closed in the peripheral direction, for example a section of a lateral surface of a frustum of cone. The middle section wall surface can also be, for example, angular, symmetrical or asymmetrical, or irregularly shaped. The middle section can define a central axis. The central axis of the middle section can be oriented transverse to the surface of the first side and/or transverse to the surface of the second side.

The second section is preferably arranged so that it is offset with respect to the middle section in the direction transverse to the first and/or the second flow-through direction. It is preferable if the offset between the first section and the second section is the same as that between the middle section and the second section, i.e., if the offset directions and offset distances are the same. The first section and the middle section can, for example, define a common central axis. It is especially preferred if the first section and the middle section define a common central axis, the central axis of the second section being offset, preferably offset in parallel, with respect to the common central axis in the direction transverse to the first and/or second flow-through direction. The second section is preferably arranged so that it is non-concentric with the middle section in the direction transverse to the first and/or the second flow-through direction. The first section and the middle section can be arranged, for example, so that they are concentric in the direction transverse to the first and/or second flow-through direction.

It is preferable for the diameter of the middle section to be less than or equal to the diameter of the first section. The middle section can, for example, abut the first section with the diameter of the first section. The cross section of the middle section of the nozzle channel tapers in the first flow-through direction. It is preferable if the cross section of the middle section of the nozzle channel tapers in the first flow-through direction over a length that is different from zero. Therefore, an aperture angle of the middle section is especially preferably less than 175°. The middle section preferably forms an abrupt taper of the flow cross section of the nozzle channel in the first flow-through direction. To accomplish this, the longest dimension of the middle section in the first or second flow-through direction is preferably less than or equal to the longest dimension of the second section in the first or second flow-through direction.

The middle section wall surface can be a section of a surface of revolution, this section being closed in the peripheral direction. The middle section wall surface is preferably a section of a lateral surface of a frustum of cone, this section being closed in the peripheral direction. The middle section wall surface preferably defines an aperture angle for the middle section that is from a minimum of 110° to a maximum of 175°. It is especially preferable for the aperture angle to be between a minimum of 120° and a maximum of 140°. For example, the middle section wall surface can have an aperture angle of 130°.

Middle section wall surfaces with such an aperture angle can form an early spraying jet that is especially suitable for premoistening.

Preferably the middle section wall surface represents an asymmetric constriction surface or guiding surface, this middle section wall surface being closed in the peripheral direction and bordering the middle section in the flow-through direction from the first side to the second side, except for an opening in the middle section wall surface that is arranged so that it is non-concentric to the central axis of the first section and that preferably is a confluence into the second section. This makes it possible for the middle section wall surface to form an asymmetric flow obstacle for the fluid in the nozzle channel in the flow-through direction from the first side to the second side.

This makes it possible to create a jet strip with a nozzle channel, this jet strip producing a jet that sprays a short distance behind the second side and that can also have a preferred direction.

The middle section wall surface can form a first guiding surface section and a second guiding surface section, the guiding surface sections being arranged opposite one another in the direction transverse to the first flow-through direction. The second guiding surface section is preferably longer in the first flow-through direction than the first guiding surface section is. It is especially preferred if the end of the second guiding surface section is downstream in the first flow-through direction, after the first guiding surface section. The first and second guiding surface sections preferably form steps in the nozzle channel that lie opposite one another in the direction transverse to the flow-through direction. Preferably, the first and second guiding surface sections begin at the same distance from the surface of the first side, however the second step formed by the second guiding surface section ends behind the first step in the first flow-through direction (downstream). The second step formed by the second guiding surface section is preferably longer in the first flow-through direction and/or in the direction transverse to the first flow-through direction than the first step that is formed by the first guiding surface section. The guiding surface sections are preferably inclined relative to a plane transverse to the first flow-through direction.

The steps or the guiding surfaces make it possible to create a nozzle channel with improved spray characteristics. In particular, it is possible to create a nozzle channel whose jet sprays at an even shorter distance to the second side. The steps that are offset with respect to one another also make it possible to create a preferred direction or deflection of the spray jet.

It is preferable for the second section to follow the middle section in the first flow-through direction. The middle wall surface and the second wall surface of the second section preferably have a transition edge between them, which can also be referred to as a confluence edge, that is closed in the peripheral direction. Preferably the closed transition edge is inclined with respect to the first and/or second flow-through direction. Preferably the transition edge is defined by a closed curve of intersection of the lateral surface of an (imaginary) cylinder or cone with the lateral surface of the (imaginary) geometric figure defining the middle wall surface. It is especially preferred if the transition edge is defined by a closed curve of intersection of the lateral surface of an (imaginary) cylinder or cone with the lateral surface of an (imaginary) frustum of cone, the axis of the cylinder or cone having an offset, preferably in parallel, to the axis of the frustum of cone. Such a transition edge can be created, for example, by arranging a first recess with a bottom that is conical or of another shape in the first side of the jet strip and arranging a second cylindrical or conical recess in the bottom of the first recess, for example by drilling or working, indentation, stamping, or shearing.

In the case of a first section and/or a middle section, each of which defines a central axis, the central axis of the first section and/or of the middle section of a nozzle channel can be taken as a reference axis to define an offset direction. The middle section or the central axis of the middle section and/or the second section or the central axis of the second section of the nozzle channel is preferably offset in a certain offset direction transverse to the reference axis and thus preferably transverse to the first and/or second flow-through direction.

It is especially preferred if the transition edge that is preferably present between the middle wall surface and the second wall surface of the second section has a first transition edge section that is arranged lying in the offset direction, and, opposite the first transition edge section, a second transition edge section that is arranged lying opposite the offset direction. Preferably the second transition edge section is arranged offset in the first flow-through direction with respect to the first transition edge section.

A longitudinal section through the middle section wall surface of the nozzle channel is preferably straight, but can also have a convex or concave curvature. The longitudinal section cut through the middle section wall surface of the nozzle channel preferably monotonically decreases from the first section all the way to the second section. In particular, the monotonic decrease through the middle section wall surface does not form any undercut transverse to the first or second flow-through direction. Preferably the entire wall bordering the nozzle channel transverse to the first and/or second flow-through direction is free of any undercuts even in the area of the first and the second section.

This makes it possible to create a nozzle channel that is free of structures that would, especially if water impinges on the jet strip on the first side and flows through from the first side to the second side, redirect the direction of flow so that the water would flow partly against the direction of flow from the first to the second side.

Preferably the middle wall surface with the diameter of the first section abuts the first wall surface of the first section. Alternatively or in addition, the middle wall surface preferably abuts the second section with the diameter of the second section. A jet strip with a nozzle channel shaped in this way is especially simple to produce.

The first section can border the middle section, it being possible for the transition from the first wall surface to the middle section wall surface to be rounded. It is especially preferred for the radius of curvature to be constant in the peripheral direction along the transition. When viewed in longitudinal section through the nozzle channel, the middle section wall surface can be arranged at an obtuse angle to the first wall surface. The angle between the first wall surface and the middle section wall surface can also be 180°. For example, the middle section and the first section of a section of the same surface of revolution, for example a lateral surface of a frustum of cone, this section being closed in the peripheral direction around the first and/or second flow-through direction, can be bordered in the direction transverse to the first and/or second flow-through direction.

Likewise, when viewed in longitudinal section through the nozzle channel, the middle section wall surface can be arranged at a reflex angle to the second wall surface. The transition edge between the middle section wall surface and the second wall surface can be rounded. At the transition between the middle section wall surface and the second wall surface, a rollover can be formed.

The curvature of the transition edge between the middle section wall surface and the second wall surface can have different radii of curvature along the edge. A rollover formed at the transition can be of different sizes along the edge. For example, the radius of curvature of the rounded transition edge in a first transition edge section arranged lying in the offset direction is greater than the radius of curvature of the rounded transition edge in an opposite second transition edge section arranged lying opposite to the offset direction. In the case of a rollover at the transition between the middle section wall surface and the second wall surface, the rollover in a first transition section arranged lying in the offset direction can be, for example, greater than in an opposite second transition edge section arranged lying opposite the offset direction.

The jet strip can consist of hardened material. Irrespective of this, the jet strip preferably has a hardened surface on the second side. The hardened surface can be limited to an area around the second orifices, this area not extending over the entire width and/or length of the surface of the second side of the jet strip. At the second openings of the nozzle channels, the hardened material or the hardened surface on the second side can create sharp edges or corners that support, in the usage position for bonding, the formation of bonding jets and are subject to reduced wear.

A jet strip extends in a longitudinal direction and a transverse direction (width). A jet strip can be several meters long. The width of the jet strip can be between 10 mm and 30 mm, for example. The thickness can be between 0.5 mm and 4 mm, for example. The nozzle channels can be arranged in one row in a longitudinal extension direction of the jet strip or, for example, in two, three, or more rows next to one another. The offset direction of the middle section and/or of the second section relative to the first section and/or the middle section can be oriented in the longitudinal extension direction and/or transverse extension direction of the jet strip. In one embodiment of a jet strip, the second sections of the nozzle channels are arranged offset in the same offset direction, so that it is also possible to speak of second sections that are offset in parallel. In another embodiment, nozzle channels of the jet strip have second sections that are offset in different offset directions.

An above-described nozzle channel is preferably created by arranging a first recess and by arranging a second recess arranged offset to it. The first recess preferably forms the first section and possibly the middle section. The second recess preferably forms the second section, it also being possible to refer to the second recess as a nozzle.

The first recess and thus especially the first section or also the middle section can be arranged, for example, by drilling, lasing, electrical discharge machining, working, indentation, or stamping.

Preferably the first section and preferably also the middle section in an above-described jet strip are formed by drilling a hole or creating a recess in the strip material by lasing or electrical discharge machining. Preferably the first section and the middle section, which can be produced, for example by drilling a hole or creating a recess by lasing or electrical discharge machining or in another way, are produced in one operation.

An above-described jet strip can be produced, for example, by the following process:

A material is prepared with a first side and a second side, this material preferably being a jet strip material. The material can be hardened, for example, or the first and/or the second side can have a hardened surface, for example. A first recess is made, for example a drill hole, with a bottom and a first diameter on the first side of the material, the first recess defining a central axis. In the case of a drill hole, the drill hole defines the central axis as a drill hole axis, for example. The central axis or the drill hole axis preferably stands transverse to the surface of the first side. At the bottom of the first recess, a second recess is made which has a second diameter that is smaller than the first diameter, this second recess being offset in the direction transverse to the central axis of the first recess, for example offset in the direction transverse to the drill hole axis of the drill hole. This can be done, for example, by punching, shearing, working, indentation, or stamping, for example with the help of a die or an indentation tool. It is also possible for the second recess to be drilled, for example. To accomplish this, the working section of the tool for producing the second recess, e.g., the die or the indentation tool, can be introduced into the first recess with an axial offset, preferably a parallel axial offset, for example in the transverse direction to the central axis of the first recess, for example the axis of the drill hole, and, to form the second recess, be advanced in a working direction, preferably parallel to the central axis of the first recess. This makes it possible to create a second recess with a central axis that is offset, preferably in parallel, in the direction transverse to the central axis of the first recess, for example the drill hole axis.

Finish machining can make the edge at the transition from the second recess to the surface of the second side of the jet strip into a sharp edge that is suitable to produce a bonding jet if the jet strip is used in the corresponding usage position. The jet strip material or the surface of the second side can also be hardened, e.g., by a suitable coating after the hole is drilled and the recess is made.

The drawings show sample embodiments of the inventive jet strip and the inventive manufacturing process.

The schematic illustrations are as follows:

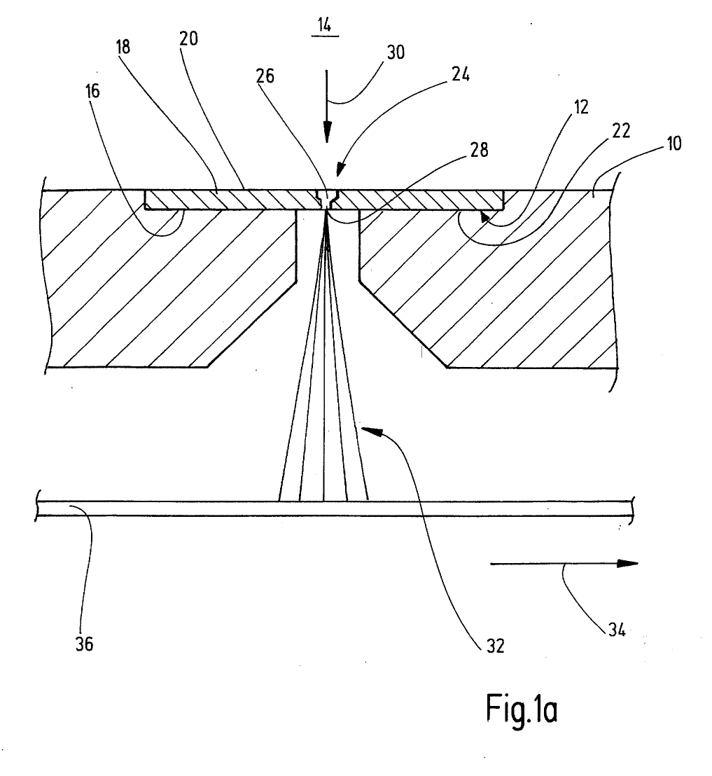

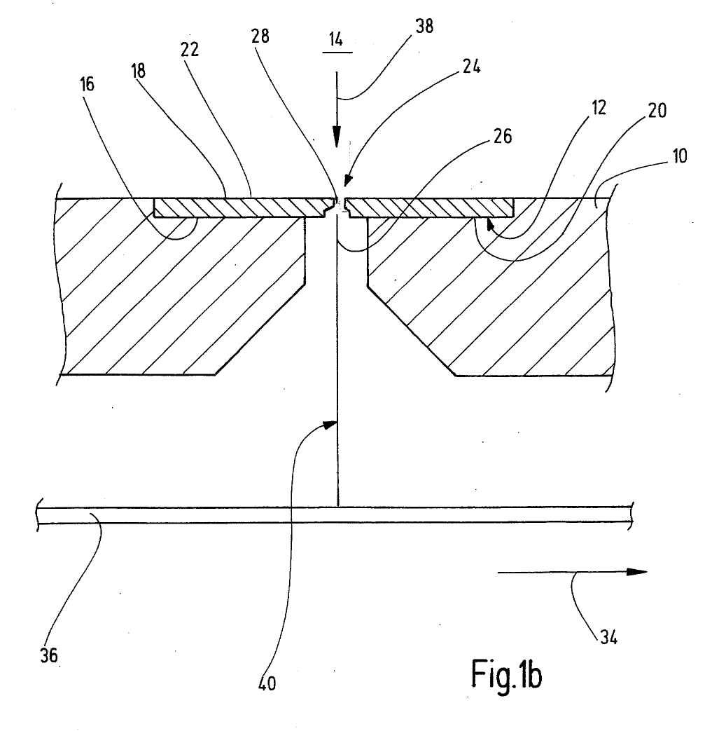

FIG. 1a—a jet beam with an inventive jet strip in a first usage position;

FIG. 1b—the jet beam from Figure la with an inventive jet strip in a second usage position;

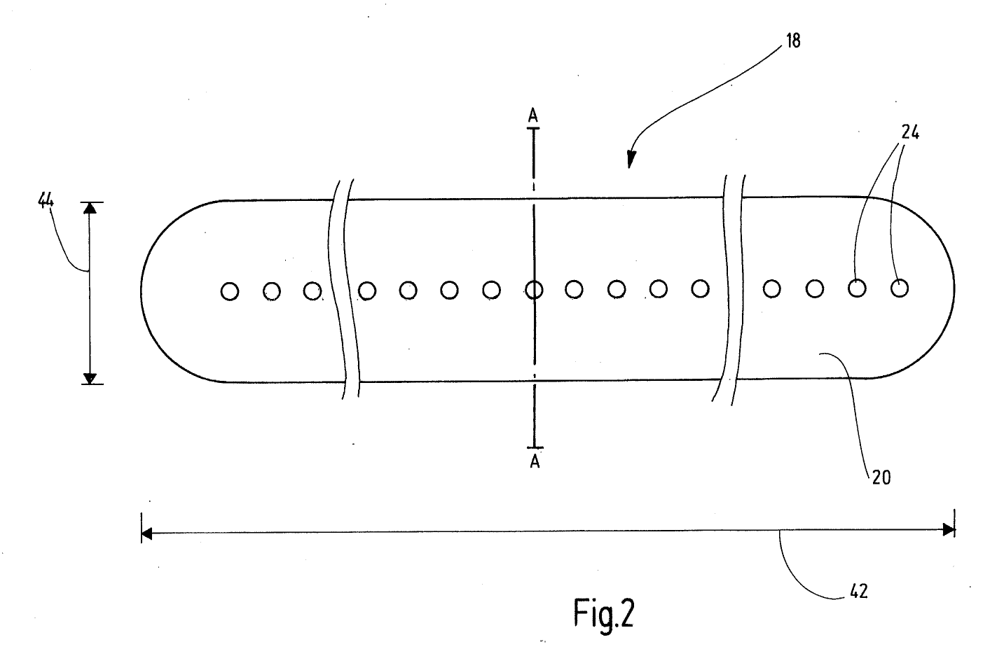

FIG. 2—top view of an inventive jet strip;

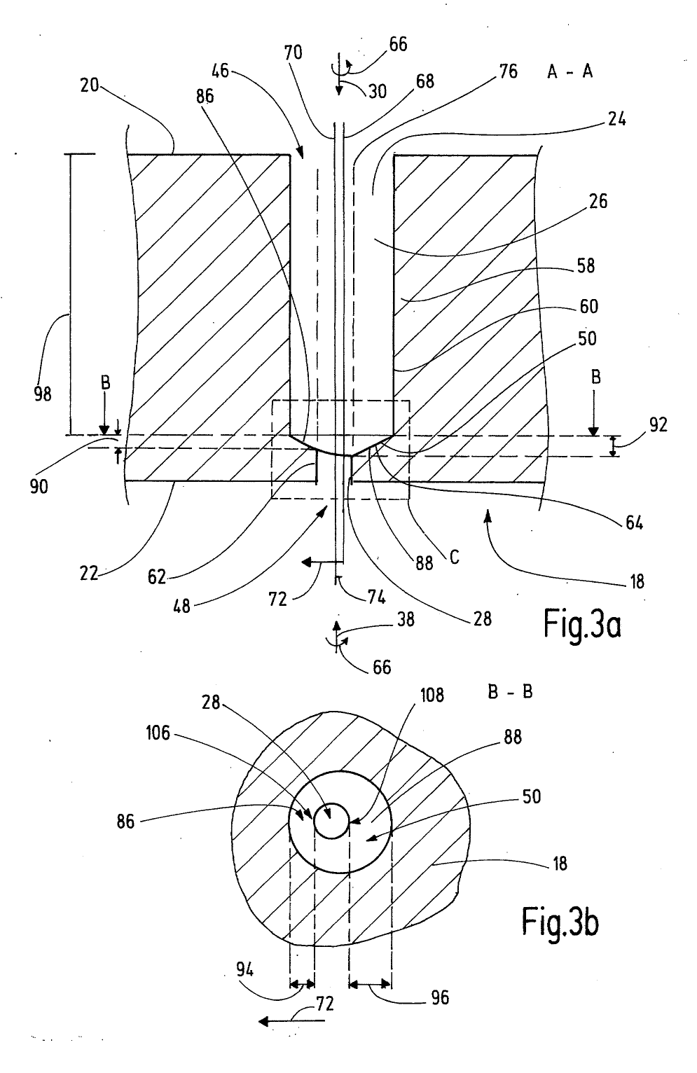

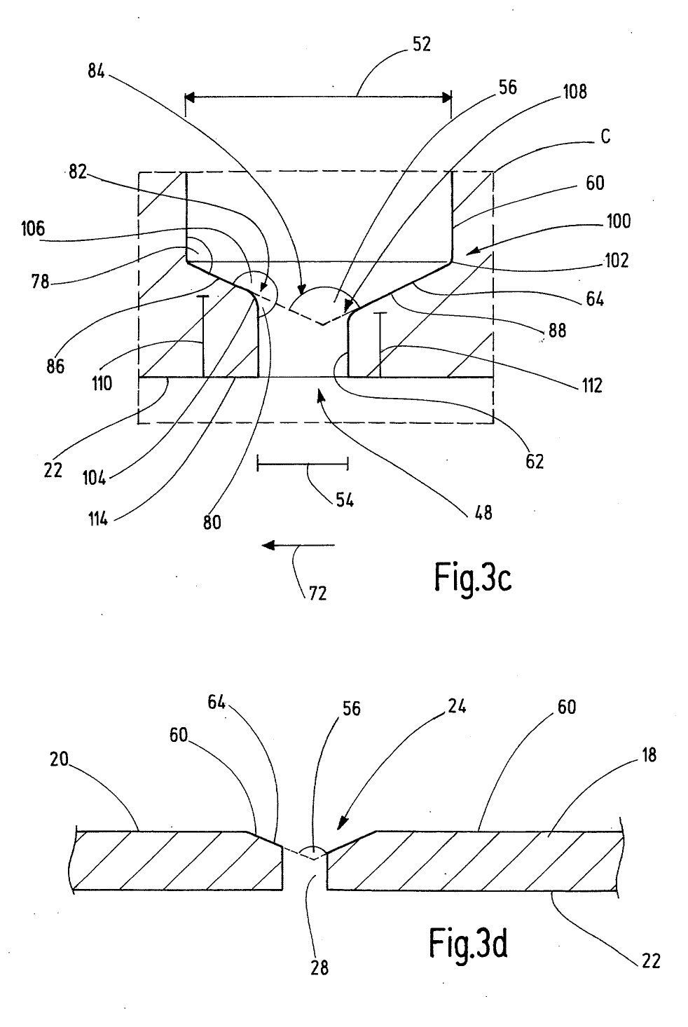

FIG. 3a—cross sectional illustration of the inventive jet strip according to FIG. 2;

FIG. 3b—a cross section through the nozzle channel of the jet strip according to FIG. 3a;

FIG. 3c—a detail of FIG. 3a;

FIG. 3d—a cross section through a nozzle channel of an alternative inventive jet strip; and

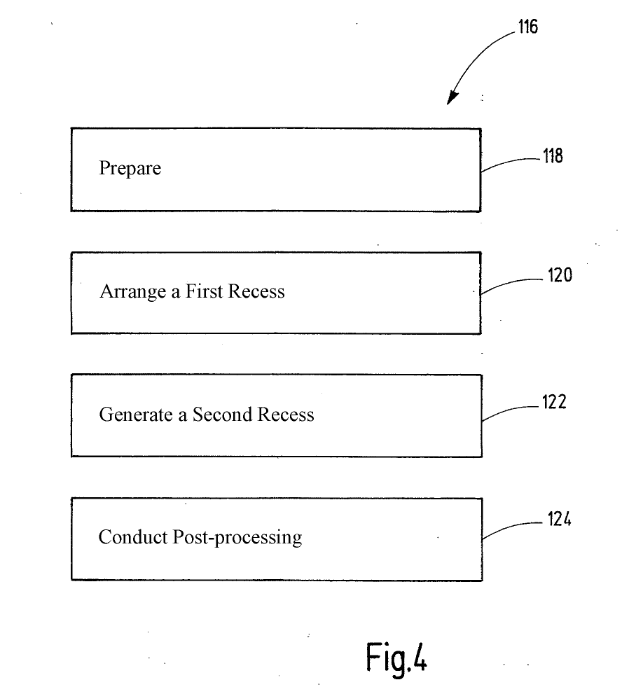

FIG. 4—a schematic representation of the inventive process.

FIG. 1a shows a jet beam 10 with a recess 12 on the pressure side 14 of the jet beam 10 for a textile processing machine. The recess 12 has a support surface 16. The recess 12 has an inventive jet strip 18 arranged in it that has a first side 20 and a second side 22. The surfaces of the first side 20 and the second side 22 are preferably parallel to one another. In a first usage position, the jet strip 18 lies with the surface of its second side 22 on the support surface 16, which is set up to support the jet strip 18 if pressurized water impinges on the pressure side 14 of the jet beam 10, and thus on the first side 20 of the jet strip 18. The jet strip has a nozzle channel 24 that has a first section 26 on the first side 20 of the jet strip 18 and a second section 28 on the second side 22 of the jet strip. The nozzle channel 24, in particular its first section 26 and second section 28, define(s) a first flow-through direction 30 from the first side 20 to the second side 22. With the jet strip 18 in this usage position, a jet 32 is produced that sprays early behind the second side 22 of the jet strip 18 and that strikes a random fiber web 36 or bonded textile that is moved in feed direction 34 and premoistens or post-processes, for example laminates, the web or textile. For premoistening, for example, water having a pressure of 5-30 bar can impinge on the first side 20 of the jet strip 18. For laminating, for example, water having a pressure of 5-250 bar can impinge on the first side 20 of the jet strip 18.

FIG. 1b shows a jet beam 10 according to FIG. 1a with an inventive jet strip 18 in a second usage position; Please refer to the above description accompanying FIG. 1a. Only a few differences are described below. The second usage position is the position that is opposite the first usage position in the sense that in this usage position it is the surface of the first side 20 of the jet strip 18 that lies on the support surface 16. Thus, the nozzle channel 24, in particular the first section 26 and the second section 28 of the channel, define(s) a second flow-through direction 38 from the second side 22 to the first side 20, so that the water first flows through the second section 28 and then through the first section 26. In this usage position, pressurized water impinges on the jet beam 10 from the pressure side 14, and thus pressurized water impinges on the second side 22 of the jet strip 18. Thus, in this usage position a bonding jet 40 is produced that strikes the web 36 of premoistened and/or prebonded random fiber or textile and entangles its fibers with one another. For bonding, for example, a pressure of 10-450 bar can impinge on the second side 22 of the jet strip 18. A sealing means (not shown) ensures that water cannot flow between the support surface 16 and the jet strip in any of the usage positions, but rather only through the nozzle channels.

FIG. 2 shows a top view of an inventive jet strip 18, looking down onto the surface of the first side 20. The jet strip 18 has a longitudinal extension 42 (length) and a transverse extension 44 (width) that define a longitudinal extension direction 42 and a transverse extension direction 44. The length can be, for example, several meters and the width can be, for example, a few centimeters. The jet strip 18 has a thickness of 1 mm, for example. Preferably the jet strip 18 has multiple nozzle channels 24 arranged one after the other in a row in the longitudinal extension 42. It is also possible for multiple rows to be arranged next to one another. The jet strip 18 is made in a single piece. It is also possible for the jet strip to be composed of multiple sections. The jet strip can consist of, for example, metal or ceramic, or it can have the mentioned materials.

FIG. 3a shows a cross section of the inventive jet strip 18 from FIG. 2, cut through the plane A-A. FIG. 3b shows a cross section of the nozzle channel 24 cut through the plane B-B from FIG. 3a. FIG. 3c shows a detail C of FIG. 3a. For a general description of the jet strip 18 in FIG. 3a, please additionally refer to the explanations for FIGS. 1a, 1b, and 2.

The unbranched nozzle channel 24 passing through the jet strip 18 extends from a first orifice 46 on the first side 20 all the way to a second orifice 48 on the second side 22. A first section 26 of the nozzle channel 18 is arranged bordering the first orifice 46 and a second section 28 is arranged bordering the second orifice 48. Alternatively, one or more other sections can be arranged between the first orifice 46 and the first section 26 or between the second orifice 48 and the second section 28. Every nozzle channel 24 in the jet strip 18 has its own first section 26 with its own first orifice 46 on the first side 20 and its own second orifice 48 on the second side 22. Alternatively, multiple nozzle channels 24 can have a common first section 26. The first section 26 and the second section 28 have a middle section 50 arranged between them. The middle section 50 borders the first section 26 and the second section 28. Alternatively, there can be another section arranged between the middle section 50 and the first section 26 and/or between the middle section 50 and the second section 28.

The diameter 52 of the first section 26 is greater than the diameter 54 of the second section 28. Preferably the diameter 52 of the first section 26 is large enough that in the usage position to produce a bonding jet after the water passes through the second section 28 it is largely unaffected by the first section 26, so that it is preferably the second section 28 that essentially determines the second flow-through direction 38. The middle section 50 of the nozzle channel 24 abruptly tapers in first flow-through direction 30 from the first side 20 to the second side 22. The aperture angle 56 of the middle section 50 is preferably no more than 175°, more preferably 110° to 175°.

In the direction transverse to the first flow-through direction 30, the nozzle channel 24 is bordered by an undercut-free channel wall 58. In particular, in the direction transverse to the flow-through direction 30 the nozzle channel 24 is bordered by the first wall surface 60 of the first section 26, the second wall surface 62 of the second section 28, and the middle section wall surface 64 of the middle section 50.

The first wall surface 60 is, for example, a lateral surface of a cylinder or a frustum of cone, these being examples of a first wall surface 60 that is preferably generally a section of a surface of revolution this section being is closed in the peripheral direction 66 around the first flow-through direction 30 and/or the second flow-through direction 38.

The second wall surface 62 of the second section 28 is, for example, a section of a lateral surface of a cylinder or a frustum of cone, this section being closed in the peripheral direction 66, these being examples of a second wall surface 62 that is preferably generally a section of a surface of revolution, this section being closed in the peripheral direction 66 around the first flow-through direction 30 and/or the second flow-through direction 38.

In the sample embodiment according to FIG. 3a, the middle section wall surface 64 is a section of lateral surface of a frustum of cone, this section being closed in the peripheral direction 66 around the first flow-through direction 30. The middle section wall surface 64 can also be, for example, another section of a surface of revolution, for example of a lateral surface of a frustum of cone, this section being closed in the peripheral direction 66 around the first flow-through direction 30. The frustum of cone shape means that the middle section wall surface 64 in the longitudinal section shown is straight through the nozzle channel 24, and thus the middle section wall surface 64 monotonically drops off in the first flow-through direction 30 from the first side 20 to the second side 22.

In one embodiment in which the first wall surface 60 and/or the second wall surface 62 are bordered by a conical wall, the aperture angle of the first wall surface 60 and/or the second wall surface 62 is/are preferably less than the aperture angle 56 of the middle section wall surface. In one embodiment in which the first section 26 and/or the second section 28 widen, the first section 26 and/or the second section 28 preferably widen(s) in the second flow-through direction 38 from the second side 22 to the first side 20.

The second section 28 is arranged offset relative to the first section 26 and, in the embodiment in FIG. 3a, also relative to the middle section 50, in the direction transverse to the first flow-through direction 30 and the second flow-through direction 38. It is possible to speak of a nozzle 28 arranged asymmetrically to the first section 26 and to the middle section 50. This is explained below using the central axis 68 of the first wall surface 60 defined by the first wall surface 60 and the central axis 70 of the second wall surface 62 defined by the second wall surface 62.

The first wall surface 60, the second wall surface 62, and/or the middle section wall surface 64, being sections of a surface of revolution that are closed in the peripheral direction 66, can each define an axis of rotation. The axis of rotation can be, for example, an axis of a cylinder or a frustum of cone, if the surfaces are sections of such a surface of revolution. The first section 26, the second section 28, and/or the middle section 50 can each define a central axis by the respective axis of rotation. In a preferred embodiment, the first section 26 and the middle section 50 define a common central axis 68. The central axis of the first section or the middle section 68 is preferably oriented transverse to the surface of the first side 20 and/or the second side 22. The central axis of the second section 70 is preferably oriented transverse to the surface of the first side 20 and/or the second side 22.

The central axis of the first section 68 and/or the central axis of the middle section 68 can serve as a reference axis for indicating an offset direction 72 of the offset and an offset distance 74 of the second section 28 relative to the first section 26 and/or the middle section 50. It is especially preferred if the central axis 70 defined by the second section 28 is offset, preferably offset in parallel, in an offset direction 72 relative to the common reference axis defined, for example, by the first section 26 and the middle section 50. In the sample embodiment the offset direction 72 of the second section 28 of the nozzle channel 24 shown is parallel to the transverse extension of the jet strip 18. Thus, the offset direction 72 lies in the plane of projection of FIGS. 3a and 3c. The offset direction 72 can generally point in the direction defined by the longitudinal extension 42 and/or in the direction defined by the transverse extension 44. It is possible to define one offset direction 72 for the second sections 28 of the nozzle channels 24 in the jet strip 18 according to FIG. 2, or to define multiple offset directions 72 for the second sections 28 of the nozzle channels 24. The nozzle channels 24 of the jet strip 18 of FIG. 2 can be the same except for the offset direction 72 of the offset between the first section 26 and the second section 28. However, the offset direction 72 can also, for example, be the same for all nozzle channels 24.

The offset distance 74 can be, for example, between a minimum of 0.01 mm and a maximum of 0.3 mm. The diameter 52 of the first section 26 can be, for example, between a minimum of 0.26 mm and a maximum of 1 mm. The diameter 54 of the second section can be, for example, between a minimum of 0.05 mm and a maximum of 0.2 mm. The offset distance 74 of the recess centers or the central axes of the first section 68 and the central axis of the second section 70 in the direction transverse to the flow-through direction 30 is, in any case, greater than the manufacturing tolerance of the first section 26 and the second section 28 with respect to one another. The manufacturing tolerance can be 0.006 mm, for example.

The offset distance 74 of the central axis of the first section 68 and the central axis of the second section 70 in the offset direction 72 is preferably less than or equal to half the difference of the diameter 52 of the first section and the diameter 54 of the second section. In the embodiment shown, the projection 76 of the second orifice 48 and the second wall surface 62 in the direction opposite the first flow-through direction 30 and onto the first side lies within the first orifice 46 and within the second wall surface 62. This produces a nozzle channel that is free of bends with simplified manufacturing.

In the embodiment shown, the central axis 68 of the first section 26 or the common central axis 68 of the first section 26 and of the middle section 50 and the central axis of the second section 70 stand transverse to the surface of the first side 20 and to the surface of the second side 22.

In the cutting plane shown in FIG. 3a, this cutting plane containing the central axis 68 of the first section, the middle section wall surface 64 is arranged at an obtuse angle 78 relative to the first wall surface 60. Alternatively, the middle section wall surface 64 can also be arranged at an angle of 180° to the first wall surface 60. In such an embodiment, the first section 26 can be in the form of a conical widening that abuts, preferably seamlessly, the middle section 50. The middle section wall surface 64 can also be arranged at an angle greater than 180° to the first wall surface 60. In the cutting plane shown in FIG. 3a, the second wall surface 62 is preferably arranged at a reflex angle 80 relative to the middle section wall surface 64.

In the embodiment shown, a second transition edge 82 is created between the middle section wall surface 64 and the second wall surface 62, this second transition edge 82 being defined by the curve of intersection of the imaginary continuation, in second flow-through direction 38, of the cylinder lateral surface bordering the second section 28 and the imaginary continuation, in first flow-through direction 30, of the frustum of cone lateral surface bordering the middle section 50.

In the embodiment shown, the middle section wall surface 64 forms an asymmetric guiding surface that is effective when fluid impinges on the nozzle channel 24 from the first side, this asymmetric guiding surface guiding the fluid, from the areas at the first wall surface 60 when the flow through the nozzle channel is in the first flow-through direction 30, to the asymmetrically arranged confluence 84 (opening) in the middle section wall surface 64, which is bordered by the transition edge 82, and into the second section 28. The guiding surface has a first guiding surface section 86 that is arranged in offset direction 72 transverse to the first flow-through direction 30, and a second guiding surface section 88 that is arranged transverse to the first flow-through direction 30 with respect to the first guiding surface section 86. The guiding surface sections 86, 88 are arranged in the fluid flow path defined by the first section 26. The extension 90 of the first guiding surface section 86 in the first flow-through direction 30 is preferably smaller than the extension 92 of the second guiding surface section 88 in the first flow-through direction 30. The extension 94 of the first guiding surface section 86 transverse to the first flow-through direction 30, in offset direction 72, is preferably smaller than the extension 96 of the second guiding surface section 88 transverse to the first flow-through direction 30, in offset direction 72. The first guiding surface section 86 and the second guiding surface section 88 can begin, for example, at the transition, defined by the first section 26 and the middle section 50, between the first wall surface 60 and the middle section wall surface 64, at the same beginning distance 98 to the first orifice 46 or the surface 20 on the first side. However, the end of the second guiding surface section 88 is preferably downstream in the first flow-through direction 30, after the first guiding surface section 86. Along the first flow-through direction 30, guiding surface sections 86, 88 are formed that are arranged at an offset, these guiding surface sections defining two offset steps of the cross sectional tapering of the flow-through channel.

The offset steps can partly break up a uniform flow through the nozzle channel 24, or cause it to swirl, which can produce an especially early spraying jet 32.

At the first transition 100 from the first wall surface 60 to the middle section wall surface 64 it is possible to form a curvature 102 of the first transition 100. Preferably, the curvature has a constant radius in the peripheral direction. Accordingly, an asymmetry of the nozzle channel 24 can preferably remain limited to the arrangement of the second section 28 relative to the first section 26 and the middle section 50, and possibly to the second transition 82.

At the second transition edge 82 from the middle section wall surface 64 to the second wall surface 62 it is possible to form a curvature 104. The curvature 104 can have different radii of curvature along the periphery of the second transition edge 82. In particular, in the case of nozzle channels 24, whose second sections 28 have been produced by working, indentation, stamping, punching, or shearing, a rollover 104 can be formed at the second transition edge 82. In one embodiment, the second transition edge 82 has, in a first transition edge section 106 arranged lying in offset direction 72, a radius of curvature or rollover that is greater than the radius of curvature or rollover of the second transition edge section 108 arranged lying opposite the offset direction 72, that is opposite the first transition edge section 106. This asymmetry can additionally affect the flow behavior.

The first transition edge section 106 lying in offset direction 72 is preferably arranged at a first distance 110 from the second orifice 48 or the surface of the second side 22, this first distance being greater than the second distance 112 of the opposite second transition edge section 108 from the second orifice 48 or the surface of the second side 22.

The second wall surface 62 preferably stands transverse to the surface 22 of the jet strip on the second side. The second orifices 48 have a hardening coating 114 arranged around them. It is also possible for the jet strip material to be hardened.

This makes the jet strip shown especially suitable for the usage position for producing a spraying jet and for the usage position for producing a bonding jet.

FIG. 3d shows another sample embodiment of a jet strip 18 with a nozzle channel 24 whose second section 28 is asymmetrically arranged with respect to the first section 26 and the middle section 50. Particularities of this sample embodiment are explained below. In other respects, the explanations and reference numbers for the sample embodiment are the same as for the other figures. In this sample embodiment, the first wall surface 60 changes into the middle section wall surface 64 at an angle of 180°. In particular both the first wall surface 60 and the middle section wall surface 64 are bordered by a section of a lateral surface of a frustum of cone, this section being closed in the peripheral direction, and both have the same aperture angle 56. The design of the first section 26 means that the jet strip 18 according to the sample embodiment in FIG. 3d might possibly be thinner than the jet strip 18 in the other sample embodiments. This can make it necessary, for example, for the surface of the first side 20 and/or the surface of the second side 22 to have one or more supporting layers (not shown) arranged on it and connected with the jet strip 18.

The jet strip according to FIGS. 1 through 3d is preferably made in one piece. It is also possible for the jet strip 18 to be composed, for example, of multiple layers laid on top of one another. For example, the first section 26 can be arranged in one layer and the middle section 50 and the second section 28 can be arranged in another layer.

FIG. 4 is a schematic representation of a manufacturing process 116 for the inventive jet strip 18, for example from FIGS. 1 through 3d.

In one step 118, a strip material is prepared. The strip material can be a hardened material, for example hardened steel. The strip material can be hardened on the second side. The strip material can have a hardened surface on the second side of a jet strip due to a coating.

In another step 120, a first recess is arranged in a first side of the strip material, this first recess having a first diameter and a bottom. This creates a first orifice 46 on the surface of the first side 20 and a first recess. The first recess can be created, for example, by drilling a hole or by lasing or by electrical discharge machining. The drill hole axis or the working axis of the laser or electrical discharge machining device can define a central axis 68 for the first recess. The first recess preferably forms the first section 26 and the middle section 50 in the completed jet strip 18.

In another step 122, a second recess is made in the bottom and in the second side 22. It is especially preferred for the second recess in the bottom and in the second side to be produced by punching, shearing, working, indentation, or stamping. It is preferred if the working section of the tool for producing the second recess, for example the working section of a punching die or an indentation tool, is arranged for this purpose in the first recess and used to produce the second recess. The working section of the tool for producing the second recess, for example the punching die or the indentation tool, preferably has an axis of symmetry, and it is preferable if this axis of symmetry of this working section is arranged offset in parallel to the central axis of the first recess. The second recess can also be created by drilling a second hole in the bottom of the first recess in the second side.

The strip material can be post-processed in another step 124. This can involve grinding or polishing the strip material, for example on the second side.

The surface of the second side can have a hardening coating applied to it. In one sample embodiment in which the second orifice 48 or the edge at the second orifice 48 has already been produced by arranging 122 the second recess, or in which the second orifice 48 only arises in a subsequent processing step, for example by grinding the second side, the area around the second orifice 48 or the edge at the second orifice 48 can be processed by grinding, polishing, and/or by applying a hardening coating.

A jet strip 18 for producing a spraying jet and a manufacturing process 116 for the jet strip 18 are indicated. A nozzle channel 24 of the jet strip 18 extends from the first side 20 to the second side 22 of the jet strip 18 and defines a flow-through direction 30, 38. A second section 28 of the nozzle channel 24 is offset relative to a first section 26 in the direction transverse to the flow-through direction 30, 38. Preferably, the nozzle channel 24 is funnel-shaped, with a middle section 50 tapering in the direction from the first side 20 to the second side 22 and with a single asymmetrically arranged funnel neck that is formed by the second section 28. The jet strip 18 can be created, for example, by drilling a hole 120 with a conically tapering bottom in a strip material and by producing 122 a recess in the bottom of the drill hole using a die or an indentation tool, with the drill hole and the recess having central axes that are offset in the transverse direction.

List of reference numbers:

| | |
|---|---|
| 10 | Jet beam |
| 12 | Recess in jet beam |
| 14 | Pressure side |
| 16 | Support surface |
| 18 | Jet strip |
| 20 | First side/surface of first side |
| 22 | Second side/surface of second side |
| 24 | Nozzle channel |
| 26 | First section |
| 28 | Second section, nozzle |
| 30 | First flow-through direction |
| 32 | Early spraying jet |
| 34 | Feed direction |
| 36 | Random fiber web, bonded textile |
| 38 | Second flow-through direction |
| 40 | Bonding jet |
| 42 | Longitudinal extension |
| 44 | Transverse extension |
| 46 | First orifice |
| 48 | Second orifice |
| 50 | Middle section |
| 52 | Diameter of first section |
| 54 | Diameter of second section |
| 56 | Aperture angle |
| 58 | Channel wall |
| 60 | First wall surface |
| 62 | Second wall surface |
| 64 | Middle section wall surface |
| 66 | Peripheral direction |
| 68 | Central axis of first section/of middle section |
| 70 | Central axis of second section |
| 72 | Offset direction |
| 74 | Offset distance |
| 76 | Projection |
| 78 | Obtuse angle |
| 80 | Reflex angle |
| 82 | Second transition edge/second transition |
| 84 | Confluence/opening |
| 86 | First guiding surface section |
| 88 | Second guiding surface section |
| 90 | Extension of first guiding surface section lengthwise |
| 92 | Extension of second guiding surface section |
| | lengthwise |
| 94 | Extension of first guiding surface section transverse |
| 96 | Extension of second guiding surface section |
| | transverse |
| 98 | Beginning distance |
| 100 | First transition |
| 102 | Curvature |
| 104 | Curvature/rollover |
| 106 | First transition edge section |
| 108 | Second transition edge section |
| 110 | First distance |
| 112 | Second distance |
| 114 | Coating |
| 116 | Manufacturing process |
| 118 | Preparing |
| 120 | Drilling a hole |
| 122 | Producing a second recess |
| 124 | Post-processing |

1. A jet strip (18) for a textile processing machine, the jet strip (18) comprising:
a first side (20) and a second side (22),
and a nozzle channel (24) that defines one or both of a first flow-through direction (30) and a second flow-through direction (38) and that has a first section (26) and a second section (28),
the nozzle channel (24) extending from the first side (20) to the second side (22), and
the second section (28) being offset relative to the first section (26) in a direction transverse to one or both of the first flow-through direction (30) and the second flow-through direction (38).

2. A jet strip (18) according to claim 1, wherein the first section (26) and the second section (28) each define a central axis (68, 70), the central axis (68) of the first section (26) being offset in parallel to the central axis (70) of the second section (70).

3. A jet strip (18) according to claim 1, wherein the first section (26) has a diameter (52) and wherein the second section (28) has a diameter (54), the offset between the first section (26) and the second section (28) being less than or equal to half the difference of the diameter (52) of the first section (26) and the diameter (54) of the second section (28).

4. A jet strip (18) according to claim 1, wherein the first section (26) is longer in one or both of the first flow-through direction (30) and the second flow-through direction (38) than the second section (28) is.

5. A jet strip (18) according to claim 1, wherein the first section (26) and the second section (28) have a middle section (50) arranged between them, the middle section (50) having a middle section wall surface (64) that borders the middle section (50) in a direction transverse to the first flow-through direction (30), and wherein the middle section (50) of the nozzle channel (24) tapers in the first flow-through direction (30).

6. A jet strip (18) according to claim 5, wherein the middle section wall surface (64) is set up to form an asymmetric guiding surface (86, 88) for fluid in the nozzle channel (24) in the first flow-through direction (30).

7. A jet strip (18) according to claim 5, wherein the middle wall surface (64) has a first guiding surface section (86) and a second guiding surface section (88), the second guiding surface section (88) having a greater extension (92) in the first flow-through direction (30), and wherein an end of the second guiding surface section (88) being after the first guiding surface section (86) in the first flow-through direction (30).

8. A jet strip (18) according to claim 5, wherein a longitudinal section cut through the middle section wall surface (64) of the nozzle channel (24) monotonically decreases over an entirety from the first section (26) to the second section (28).

9. A jet strip (18) according to claim 5, wherein the first section (26) has a first wall surface (60), the second section (28) has a second wall surface (62), and the middle section (50) has a middle section wall surface (64) that borders the middle section (50) in the direction transverse to the one or both of the first flow-through direction (30) and the second flow-through direction (38) and wherein one or both of:
a transition (82) between the second wall surface (62) and the middle section wall surface (64) has a reflex angle (80), and
a transition (100) between the first wall surface (60) and the middle section surface (64) has an obtuse angle (78).

10. A jet strip (18) according to claim 5, wherein the middle section (50) is bordered by a lateral surface of a frustum of cone, wherein a central axis (68) that is defined by the frustum of cone lateral surface coincides with a central axis (68) that is defined by the first section (26).

11. A jet strip (18) according claim 5, wherein the middle section (50) has an aperture angle (56) of 110° to 175°.

12. A jet strip (18) according to claim 1, wherein the jet strip (18) has a hardened surface in or near the second sections (28) on the second side (22).

13. A jet strip (18) according to claim 1, wherein the second section (28) is offset in the longitudinal extension direction (42) and/or a transverse extension direction (44) of the jet strip.

14. A jet strip (18) according to claim 1, wherein the first section (26) and the middle section (50) are produced by drilling a hole in a strip material.

15. A manufacturing process (116) for a jet strip (18) according to claim 1, the process (116) comprising:
Preparing (118) a material with a first side and a second side;
Producing (120) a first recess comprising a drill hole with a bottom in the material on the first side, the first recess defining a central axis;
Producing (122) a second recess in the bottom of the first recess by one or more of punching, shearing, working, indentation, or stamping, this second recess being offset in a direction transverse to the central axis.
